(19) United States
(12) Patent Application Publication
(10) Pub. No.: US 2024/0070366 A1
(43) Pub. Date: Feb. 29, 2024

(54) ADAPTIVE TRACE WIDTH IN MULTI-LAYER SUBSTRATE PACKAGE

(71) Applicant: Intel Corporation, Santa Clara, CA (US)

(72) Inventors: Nicholas HAEHN, Scottsdale, AZ (US); Raquel DE SOUZA BORGES FERREIRA, Ocala, FL (US); Siddharth ALUR, Chandler, AZ (US); Prakaram JOSHI, Gilbert, AZ (US); Dhanya ATHREYA, Chandler, AZ (US); Yidnekachew MEKONNEN, Chandler, AZ (US); Ali HARIRI, Phoenix, AZ (US); Andrea NICOLAS, Chandler, AZ (US); Sri Chaitra Jyotsna CHAVALI, Chandler, AZ (US); Kemal AYGUN, Tempe, AZ (US)

(21) Appl. No.: 17/895,107

(22) Filed: Aug. 25, 2022

(51) Int. Cl. G06F 30/392; H01L 23/498

(52) U.S. Cl. CPC G06F 30/392; H01L 23/49838; G06F 2119/22; H01L 23/49822

(57) ABSTRACT

A package substrate stack modeler includes a manufacturing modeler, configured to generate a model of a real package substrate stack based on an ideal design of the package substrate stack; a signal integrity model, configured to determine a signal integrity of a metal trace of the real package substrate stack; and a yield model, configured to determine a yield of the real package substrate stack; wherein the metal trace comprises a first value of a trace variable; further comprising a processor, configured to select a second value of the trace variable of the metal trace based on the determined signal integrity of the metal trace or the determined yield of the package substrate stack model.

### TECHNICAL FIELD

Various aspects of this disclosure generally relate to the design of a metal trace in a multilayer substrate package.

### BACKGROUND

The performance of a multi-layer substrate package (e.g. for use with a semiconductor) is often governed or constrained by design limitations. That is, directly affects many factors that contribute to the overall quality and function of a substrate. Such factors may include signal integrity (SI) (e.g. performance), yield (Y) (e.g. cost) and manufacturability (M) (e.g. time to market). Heterogeneous packaging and next generation industry standards require higher signal speeds and bandwidth while integrating advanced manufacturing technology (e.g. embedded multi-die interconnect bridges (EmIB)), often in a shrinking form factor, all while maintaining yield. Each of these three vectors (performance, cost and manufacturability) often require conflicting design changes, resulting in an inevitable compromise.

For example, and turning to high-speed routing like Double Data Rate (DDR) routing or Peripheral Component Interconnect Express (PCIE) routing, (each of which may be referred to herein as “regions”), each region is subject to target design rules on parameters that affect the signal integrity, yield and manufacturability. FIG. 1 depicts a cross-section of a high-speed substrate routing shown in a stripline configuration with the primary parameters defined by the trace width (TW), trace-trace space (TS), trace thickness (TT), and the dielectric thicknesses above and below the traces, (DT1 and DT2, respectively). These are the primary parameters that will govern signal integrity characteristics (i.e. impedance, insertion loss and cross-talk). All principles discussed herein also apply to other routing configurations such as microstrip with corresponding primary parameters that govern signal integrity characteristics. Ideally, each of these parameters would be uniform within a given region to optimize the signal integrity and manufacturability of the design. Unfortunately, physics-induced nonuniformities preclude realization of an ideal substrate routing.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a cross-section of a high-speed substrate routing;

FIG. 2 depicts the resulting impact on within-trace variability;

FIG. 3 depicts an example substrate layer;

FIGS. 4-7 show parameters extracted along traces 302 and 304 from FIG. 3;

FIG. 8 depicts a comparison of conventional design 800 versus adaptive design;

FIG. 9 depicts a package substrate stack modeler; and

FIG. 10 depicts a method of modelling a package substrate stack.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

During the design phase for a routing layer, TW and TS are effectively fixed for a given region and DT1 is primarily determined from the previous layer. The remaining two parameters, TT and DT2, depend on the manufacturing physics. Unfortunately, the physics are highly sensitive to the design (TW and TS) itself, which directly impacts both the electroplating process (which determines TT) and the lamination process (which determines DT2). It should also be noted that the TT also influences DT2.

Manufacturing considerations play a significant role in trace design and the corresponding compromises. Ideally, each copper layer and each dielectric layer of a substrate stack could be perfectly flat; however, this is not possible with existing manufacturing technology. Rather, the available processes for plating the copper leads to non-uniformities in the layer thickness/height, such that each layer deviates from the ideal, flat configuration (e.g. each layer is uneven), and generally at different portions of the layer. The unevenness of the layers is relevant to the stack's critical performance metrics. For example, with respect to signal integrity, because the trace thickness varies, the impedance varies along the trace. Changes in impedance along the trace may result in decreased performance, such as reduced signal strength, voltage drop, etc.

Other manufacturing considerations play a role here too. In current manufacturing technology, trace patterns may be transferred to a layer in a lithography process using a resist layer. Such resists may be a predetermined maximum thickness (e.g. 22 μm). Should a TT exceed the predetermined thickness of resist, the metal will plate through the resist, which may impair signal integrity and/or decrease yield.

Various aspects of the disclosure describe the use of a mechanical model to model or predict physical characteristics of a real metal (e.g. trace) layer. This may be understood, for example, as modelling or predicting deviations in a manufactured layer or stack (e.g. the “real” layer, the “real” stack) from the designed layer or stack (e.g. the “ideal” layer, the “ideal” stack). Using this information, a trace variable can be modified to improve the signal integrity and/or the yield. Similarly, with these modifications, the manufacturing prediction (e.g. the prediction of the “real” layer or stack) can be altered. According to an aspect of the disclosure, the trace variable to be modified may be the trace width (TW). Although the principles and method of this disclosure are described throughout with respect to changes in the TW, changes to other trace variable could alternatively be used.

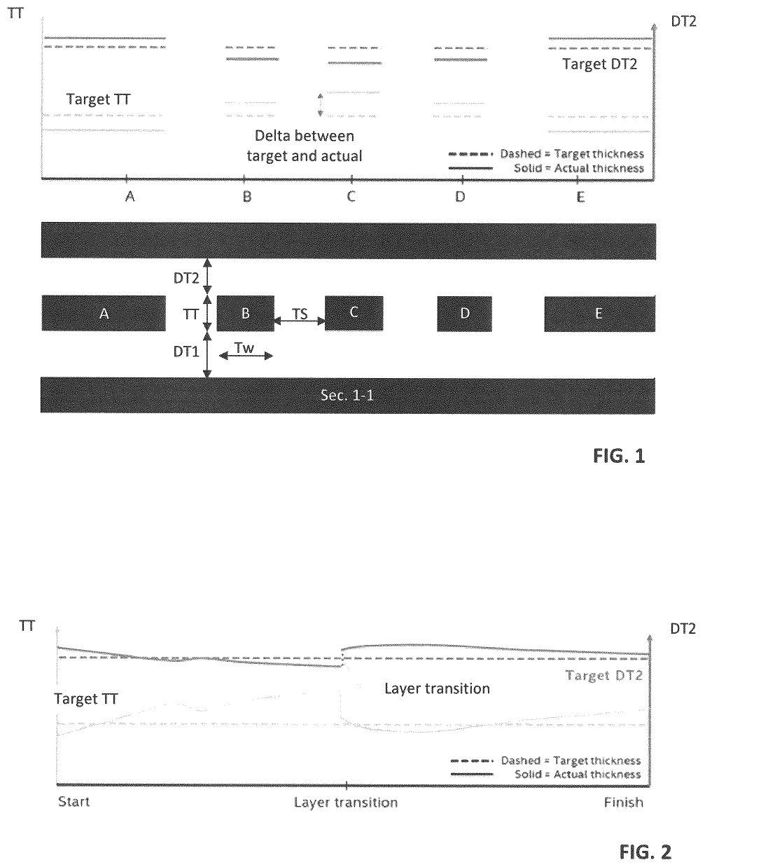

Returning to FIG. 1, FIG. 1 demonstrates the effects of trace-to-trace variability. In this figure, trace C will have a higher TT than traces B and D, which will in turn have a greater thickness than the surrounding ground planes A and E. Likewise, trace C will have a lower DT2 than traces B and D, which will in turn have a greater thickness than the surrounding planes A and E.

This has two important consequences. First, electrical characteristics between different traces cannot be perfectly matched. This means that the impedance, cross-talk, and insertion losses will all be different for each trace. Second, manufacturing specifications will become harder to meet, resulting in more costly or time-consuming manufacturing processes.

In conventional procedures, the TW is invariant (e.g. a consistent TW throughout the layer), or in limited circumstances, the TW may undergo a single stepwise change within the layer, such as toward an exterior portion of the layer (e.g. around the edges), such as in preparation for a layer transition (e.g. using a via) or in preparation for connection to an external device.

Many of the signal integrity, manufacturing, or yield considerations can be mollified by selecting a trace variable (e.g. thickness (TT), height (TH), trace-trace space (TS), or thickness above or below the metal layer (DT1, DT2)) to be adaptively modified to control for detriments to performance indicators resulting from any one or more of the other trace variables. In an exemplary configuration, the trace variable to be adaptively modified by the TW.

FIG. 2 depicts the resulting impact on within-trace variability. As a signal propagates along a trace, it will experience significant variation in TT and DT2. Because the signal-integrity performance is highly sensitive to these two parameters, a performance metric like impedance (Z) will change, sometimes dramatically, along the trace. Sharp impedance changes along a signal direction will result in reflections and increased losses. Furthermore, the cross-talk, which is sensitive to the TT of two nearby traces, can vary along the trace direction.

FIG. 2 also demonstrates another important challenge that arises when traces are forced to span multiple routing layers. Transitions between layers are represented by a discontinuous jump in TT and DT2. Otherwise stated, on any given layer, the trace has both an origin and a termination, which usually leads to a via chain dropping to another layer or, ultimately, the board level pin-out. Where the trace drops to a different layer for additional routing, there is no way to guarantee that TT and DT2 are well-matched between the termination of the first layer and the origin of the second layer where the routing is to occur.

According to an aspect of the disclosure, the TW can be adapted (e.g. varied) to compensate for variations in any of TT, DT1, or DT2, such as, for example, variations that result from the physics of the manufacturing processes. This varying TW, which may be referred to herein as “adaptive design”, may permit designers to compensate for changes in any of TT, DT1, or DT2, and to optimize the vectors of performance, cost, and manufacturability.

Mathematically, for each region, the TW, which is conventionally a constant (e.g. TW=C), may be designed and/or determined as a function of x and y, (TW=(x, y)), wherein x and y are within the plane of the unit.

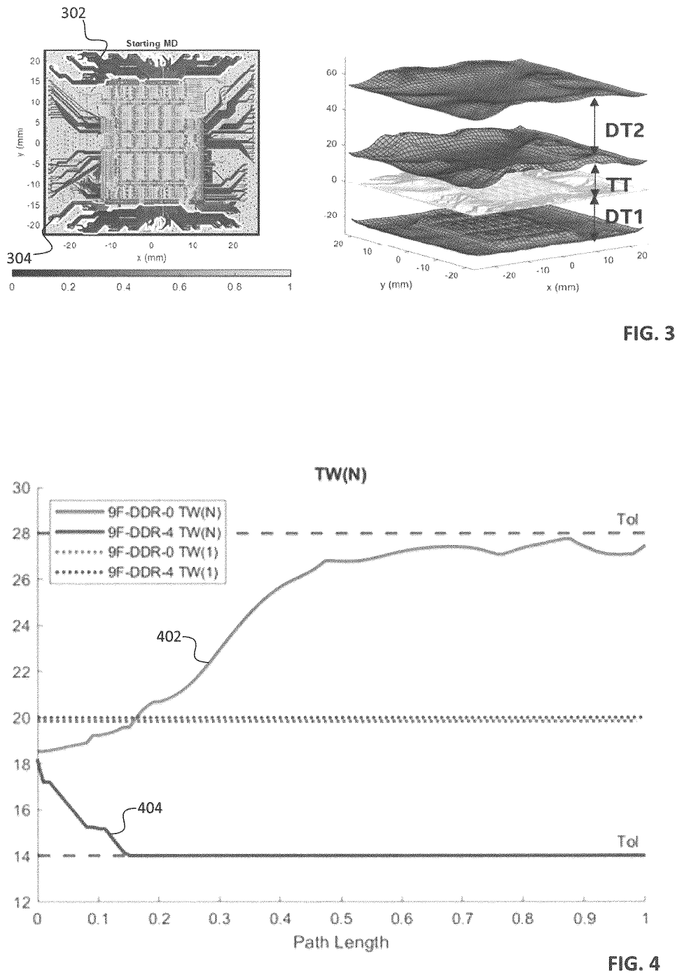

FIG. 3 depicts a sample 9F layer from a substrate design. In the left image, the DDR region is outlined by a solid white line. On the left, the metal density distribution is depicted, and the white outline demarcates a ‘region’ definition used for adaptive design. Two traces 302 and 304 will be used to visualize the behavior of the adaptive design algorithms. On the right, a three-dimensional (3D) illustration is depicted, which shows the spatial distribution of TT and DT2.

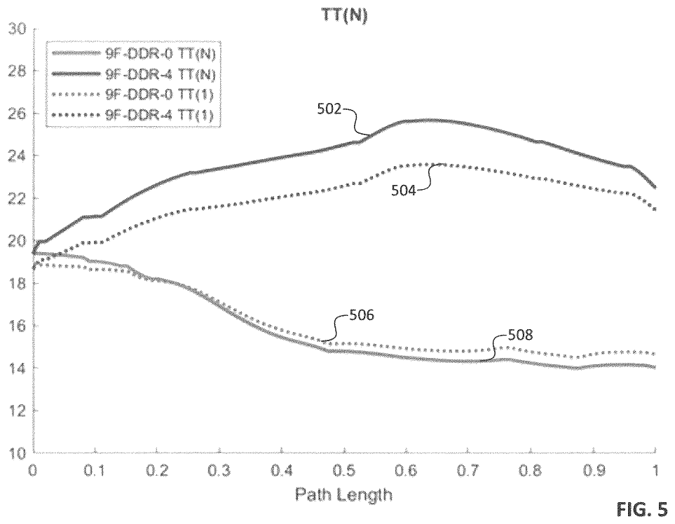

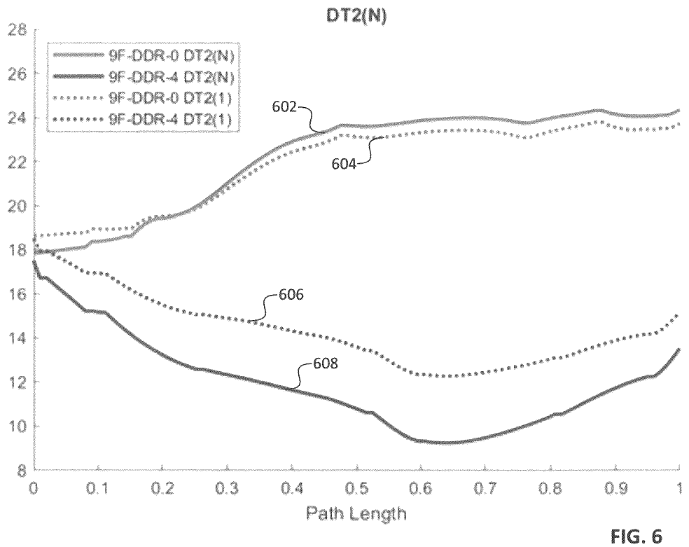

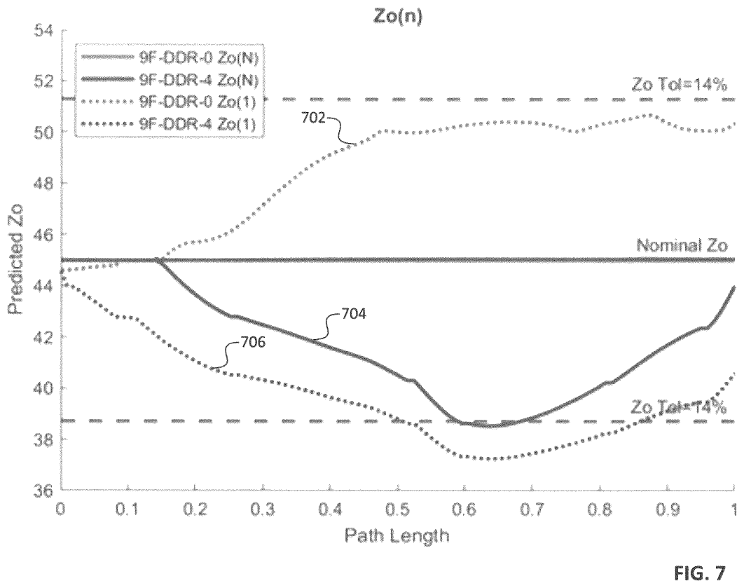

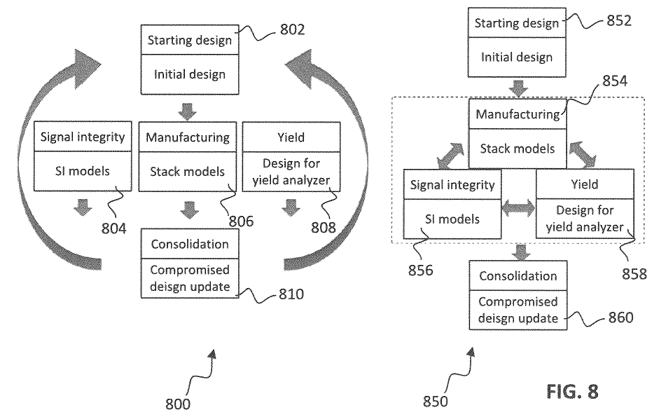

FIGS. 4-7 show parameters extracted along traces 302 and 304 from FIG. 3. The dashed lines show the initial starting variations of the various parameters, which would represent current best practices. As a cross-reference, FIG. 4 lines 402 and 404 correspond to FIG. 3, traces 304 and 302, respectively. FIG. 5 lines 502 and 508 correspond to FIG. 3, traces 302 and 304, respectively. FIG. 6 lines 602 and 608 correspond to FIG. 3, traces 304 and 302, respectively. FIG. 7 line 704 corresponds to FIG. 3 trace 302 (FIG. 3 trace 304 corresponds to “nominal Zo” in FIG. 7).

In FIG. 4, the TW begins at a constant 20 μm and does not vary along the length of the trace. Conversely, the other three plots, (FIGS. 5-7), show that the TT, DT2 and the characteristic impedance all display significant variation along the trace width, again, focusing on the dashed lines representing current designs.

Upon completion of the adaptive design procedure as disclosed herein, the two traces end up with different TW values along each trace. The trace of FIG. 3, 304 is in a region in which the TW was required to increase from the nominal 20 um. In comparison, the trace of FIG. 3, 302 required the TW to decrease achieve a target impedance. The lower spec limit on the TW was reached and formed a lower limit. In turn, this limited how much compensation the TW could provide to trace of FIG. 3, 302 to increase the impedance along much of that curve. Already, this represents an improvement over conventional standards. Conversely, for the trace of FIG. 3, 304, the impedance was fully compensated and ended in a flat and on-target impedance.

FIG. 8 depicts a comparison of conventional design 800 versus adaptive design 850. In a conventional process, the initial design 802 is separately evaluated and modified by a signal integrity module 804, a stack model (e.g. for deviations from the ideal due to manufacturing processes and tolerances) 806, and a yield model 808. These may occur in parallel and are generally executed on separate platforms. The results of each of these three models are then harmonized in a consolidation step 810, during which compromises are arrived at for each of the three models. This procedure may be repeated to achieve iterative changes in the overall design. In this manner, the final design represents a compromise between signal integrity, manufacturing, and yield. Of note, this procedure is unlikely to result in optimizations between these variables.

A significant drawback of this procedure 800 is that signal integrity and yield are calculated based on ideal designs, rather than real designs (e.g. designs that deviate from the idea designs, such as due to manufacturing processes and/or tolerances). Manufacturing processes, however, may result in meaningful deviations from the ideal design, and changes in trace variables to achieve improved signal integrity and/or yield based on ideal designs rather than real manufactures (or in this case, models of real manufactures), will not achieve or approach optimization.

Similarly, changes in the trace parameters to improve yield may negatively affect signal integrity and manufacturing results. Efforts to improve yield without considering these factors will not achieve or approach optimization.

Turning to the adaptive model, independent predictive models for Signal Integrity, Yield and Manufacturing are combined into a single platform, which allows dynamic data communications between the different models. Each of these predictive capabilities include: signal integrity performance metrics based on channel stack-up dimensions (Impedance, cross-talk and insertion loss); stack modeling for spatially resolved substrate manufacturing dimensional stackups; and a Design for Yield tool for predictive patterning yield loss predictive estimates. The adaptive model further includes a library of advanced analysis methods to facilitate advanced co-optimization schemes using real-time dynamic data feeds between models. The adaptive model includes advanced co-optimization schemes and visualization tools to balance the integrated and highly coupled nature of the different objectives. The adaptive model further includes automation tools to convert vectorized design databases into numerical arrays suitable for mathematical operations as an input to predictive model tools. The adaptive model further includes automation tools to receive the optimized TW spatially resolved compensation maps and operate on the vectorized design database to apply the required TW biases in a way compatible with today's design rules.

In this manner, the adaptive model begins with an initial design 852 and performs the manufacturing model evaluation 854, the signal integrity evaluation 856, and the yield evaluation 858 on a common platform, such any of these models may consider and/or incorporate data/results from any other model or a combination of the other models. In this manner, the signal integrity model 856 may evaluate the signal integrity based on data from the manufacturing model 854 and/or the yield model 858. The manufacturing model 854 may evaluate the signal integrity based on data from the signal integrity model 856 and/or the yield model 858. The yield model 858 may evaluate the signal integrity based on data from the manufacturing model 854 and/or the signal integrity model 856. The results may be consolidated and/or modified to reach further compromise 860.

As stated above, all predictive capabilities may be executed on a single platform, which may allow for real-time data sharing. In turn, this facilitates the use of advanced analysis methods and co-optimization algorithms to run in parallel.

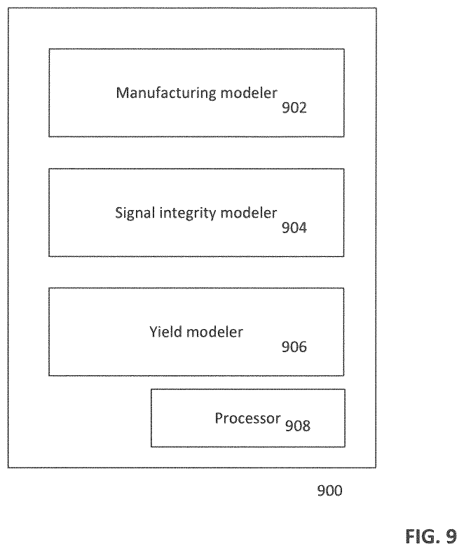

The principles of adaptive design disclosed herein may be configured as a package substrate stack modeler. FIG. 9 depicts a package substrate stack modeler 900, according to an aspect of the disclosure. The package substrate stack modeler 900 may include a manufacturing modeler 902, configured to generate a model of a real package substrate stack based on a design (e.g. an ideal design) of the package substrate stack; a signal integrity modeler 904, configured to determine a signal integrity of a metal trace of the real package substrate stack; a yield modeler 906, configured to determine a yield of the real package substrate stack; wherein the metal trace comprises a first trace width. Each of the manufacturing modeler 902, the signal integrity modeler 904, and the yield modeler 906 may be configured as software, configured to, upon execution by one or more processors, perform the function(s) for which they are disclosed herein. Each of these modelers may be configured to receive the trace design (e.g. an ideal design) and/or data from any one or both of the remaining modelers and to perform its modeling task(s) using the trace design and/or the data.

These modelers may be executed by the same processors or groups of processors. Alternatively, they may be each executed by their own respective processor or processors. According to an aspect of the disclosure, it may be desirable for each of these modelers to operate within the same platform, so that data may be more easily shared between modelers. Alternatively, the modelers may be executed on different platforms, with a mechanism for each of data sharing, such as with an orchestrator in a containerization schema.

The package substrate stack modeler 900 may further include a processor 908, configured to select a second trace width of the metal trace based on the determined signal integrity of the metal trace or the determined yield of the package substrate stack model.

The processor 908 may be optionally configured to select the second trace width based on the determined signal integrity and the determined yield. The processor 908 may be optionally configured to select the second trace width based on the model of the real package substrate stack. According to an aspect of the disclosure, generating the model of the real package substrate stack may comprise determining one or more deviations from the ideal design of the package substrate stack resulting from one or more manufacturing processes.

According to an aspect of the disclosure, the processor 908 may be further configured to change the trace width of the model of the real package substrate stack or the ideal design of the package substrate stack from the first trace width to the second trace width.

The metal trace may comprise a first trace portion and a second trace portion; wherein the first trace width is a trace width of the first portion, the second trace width is an amended trace width of the first portion; wherein the second trace portion comprises a third trace width; and wherein the processor is further configured to select a fourth trace width of the second trace portion based on the determined signal integrity of the metal trace or the determined yield of the package substrate stack model.

The processor 908 may be optionally configured to select the fourth trace width based on the determined signal integrity of the metal trace and the determined yield of the package substrate stack model. The processor may be further configured to select the fourth trace width based on the model of the real package substrate stack. The processor may be further configured to change the third trace width of the model of the package substrate stack or the ideal design of the package substrate stack from the third trace width to the fourth trace width. The processor may be configured to select the second trace width and/or the fourth trace width as a function of the signal integrity and the yield.

According to an aspect of the disclosure, the stack modeler 900 may be configured to generate the model of the real manufacture of the layer design by spatially resolving substrate manufacturing stacks. Determining the signal integrity of the metal trace may optionally include determining any of impedance of the metal trace, cross talk between the metal trace and another metal trace, or insertion loss of the metal trace. Determining the signal integrity of the metal trace may optionally include determining any of impedance of the metal trace, cross talk between the metal trace and another metal trace, or insertion loss of the metal trace. Determining the yield of the real package substrate stack may optionally include determining an amount of yield loss of the real package substrate stack.

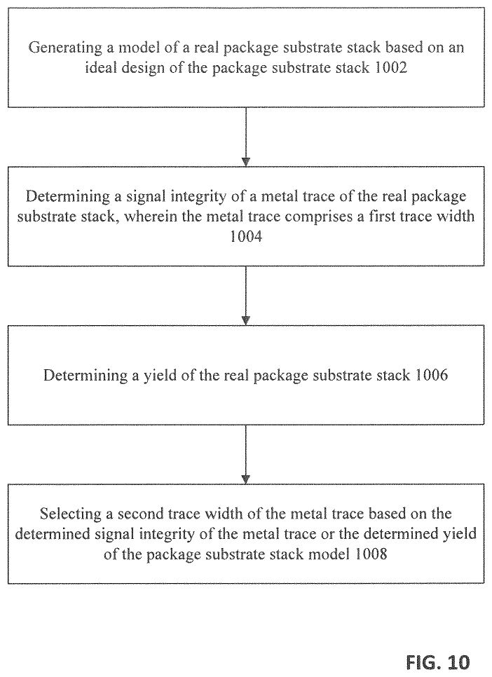

FIG. 10 depicts a method of modelling a package substrate stack, comprising: generating a model of a real package substrate stack based on an ideal design of the package substrate stack 1002; determining a signal integrity of a metal trace of the real package substrate stack, wherein the metal trace comprises a first trace width 1004; determining a yield of the real package substrate stack 1006; and selecting a second trace width of the metal trace based on the determined signal integrity of the metal trace or the determined yield of the package substrate stack model 1008.

Any method disclosed herein may be performed as part of a non-transitory computer readable medium, comprising instructions which, if executed, cause one or more processors to perform the method. According to an aspect of the disclosure, the non-transitory computer readable medium may be a memory.

According to an aspect of the disclosure, adaptive changes in the trace width as disclosed herein may result in gradient changes of the trace with along a length of the metal trace. This may be in contrast to “stepwise” transitions, which may be visible, at least in limited number, and select examples of conventionally-manufactured stacks. That is, the changes in the trace width as disclosed herein may be repeatedly performed such that a gradual or gradient change of trace width along the trace is present. To the extent that the procedures disclosed herein represent a series of stepwise changes to trace width, the changes may be smoothed to result in a gradual or gradient change along a length of the trace width.

Additional aspects of the disclosure will be disclosed by way of example:

In Example 1, a package substrate stack modeler, comprising: a manufacturing modeler, configured to generate a model of a real package substrate stack based on an ideal design of the package substrate stack; a signal integrity model, configured to determine a signal integrity of a metal trace of the real package substrate stack; a yield model, configured to determine a yield of the real package substrate stack; wherein the metal trace comprises a first trace width; further comprising a processor, configured to select a second trace width of the metal trace based on the determined signal integrity of the metal trace or the determined yield of the package substrate stack model.

In Example 2, the package substrate stack modeler of Example 1, wherein the processor is configured to select the second trace width based on the determined signal integrity and the determined yield.

In Example 3, the package substrate stack modeler of Example 2, wherein the processor is further configured to select the second trace width based on the model of the real package substrate stack.

In Example 4, the package substrate stack modeler of any one of Examples 1 to 3, wherein generating the model of the real package substrate stack comprises determining one or more deviations from the ideal design of the package substrate stack resulting from one or more manufacturing processes.

In Example 5, the package substrate stack modeler of any one of Examples 1 to 4, wherein the processor is further configured to change the trace width of the model of the real package substrate stack or the ideal design of the package substrate stack from the first trace width to the second trace width.

In Example 6, the package substrate stack modeler of Example 1 or 5, wherein the metal trace comprises a first trace portion and a second trace portion; wherein the first trace width is a trace width of the first portion, the second trace width is an amended trace width of the first portion; wherein the second trace portion comprises a third trace width; and wherein the processor is further configured to select a fourth trace width of the second trace portion based on the determined signal integrity of the metal trace or the determined yield of the package substrate stack model.

In Example 7, the package substrate stack modeler of Example 6, wherein the processor is configured to select the fourth trace width based on the determined signal integrity of the metal trace and the determined yield of the package substrate stack model

In Example 8, the package substrate stack modeler of Example 7, wherein the processor is further configured to select the fourth trace width based on the model of the real package substrate stack.

In Example 9, the package substrate stack modeler of Example 8, wherein the processor is further configured to change the third trace width of the model of the package substrate stack or the ideal design of the package substrate stack from the third trace width to the fourth trace width.

In Example 10, the package substrate stack modeler of any one of Examples 1 to 9, wherein the processor is configured to select the second trace width and/or the fourth trace width as a function of the signal integrity and the yield.

In Example 11, the package substrate stack modeler of any one of Examples 1 to 10, wherein the stack model is configured to generate the model of the real manufacture of the layer design by spatially resolving substrate manufacturing stacks.

In Example 12, the package substrate stack modeler of any one of Examples 1 to 11, wherein determining the signal integrity of the metal trace comprising determining any of impedance of the metal trace, cross talk between the metal trace and another metal trace, or insertion loss of the metal trace.

In Example 13, the package substrate stack modeler of any one of Examples 1 to 12, wherein determining the signal integrity of the metal trace comprises determining any of impedance of the metal trace, cross talk between the metal trace and another metal trace, or insertion loss of the metal trace.

In Example 14, the package substrate stack modeler of any one of Examples 1 to 13, wherein determine the yield of the real package substrate stack comprises determining an amount of yield loss of the real package substrate stack.

In Example 15, a non-transitory computer readable medium, comprising instructions which, if executed by one or more processors, are configured to cause the one or more processors to: generate a model of a real package substrate stack based on an ideal design of the package substrate stack; determine a signal integrity of a metal trace of the real package substrate stack, wherein the metal trace comprises a first trace width; determine a yield of the real package substrate stack; and select a second trace width of the metal trace based on the determined signal integrity of the metal trace or the determined yield.

In Example 16, the non-transitory computer readable medium of Example 15, wherein the instructions are further configured to cause the one or more processors to select the second trace width based on the determined signal integrity and the determined yield.

In Example 17, the non-transitory computer readable medium of Example 16, wherein the instructions are further configured to cause the one or more processors to select the second trace width based on the model of the real package substrate stack.

In Example 18, the non-transitory computer readable medium of any one of Examples 15 to 17, wherein the instructions are further configured to cause the one or more processors to change the trace width of the model of the real package substrate stack or the ideal design of the package substrate stack from the first trace width to the second trace width.

In Example 19, the non-transitory computer readable medium of Example 15 or 18, wherein the metal trace comprises a first trace portion and a second trace portion; wherein the first trace width is a trace width of the first portion, the second trace width is an amended trace width of the first portion; wherein the second trace portion comprises a third trace width; and wherein the instructions are further configured to cause the one or more processors to select a fourth trace width of the second trace portion based on the determined signal integrity of the metal trace or the determined yield of the package substrate stack model.

In Example 20, the non-transitory computer readable medium of Example 19, wherein the instructions are further configured to cause the one or more processors to select the fourth trace width based on the determined signal integrity of the metal trace and the determined yield of the package substrate stack model

In Example 21, the non-transitory computer readable medium of Example 20, wherein the instructions are further configured to cause the one or more processors to select the fourth trace width based on the model of the real package substrate stack.

In Example 22, the non-transitory computer readable medium of Example 21, wherein the instructions are further configured to cause the one or more processors to change the third trace width of the model of the package substrate stack or the ideal design of the package substrate stack from the third trace width to the fourth trace width.

In Example 23, the non-transitory computer readable medium of any one of Examples 15 to 22, wherein the instructions are further configured to cause the one or more processors to select the second trace width and/or the fourth trace width as a function of the signal integrity and the yield.

In Example 24, the non-transitory computer readable medium of any one of Examples 15 to 23, wherein the instructions are further configured to cause the one or more processors to generate the model of the real manufacture of the layer design by spatially resolving substrate manufacturing stacks.

In Example 25, a method of modelling a package substrate stack, comprising:

generating a model of a real package substrate stack based on an ideal design of the package substrate stack; determining a signal integrity of a metal trace of the real package substrate stack, wherein the metal trace comprises a first trace width; determining a yield of the real package substrate stack; and selecting a second trace width of the metal trace based on the determined signal integrity of the metal trace or the determined yield of the package substrate stack model.

In Example 26, the method of modelling the package substrate stack of Example 25, wherein selecting the second trace width comprises selecting the second trace width based on the determined signal integrity and the determined yield.

In Example 27, the method of modelling the package substrate stack of Example 26, further comprising selecting the second trace width based on the model of the real package substrate stack.

In Example 28, the method of modelling the package substrate stack of any one of Examples 25 to 27, further comprising changing the trace width of the model of the real package substrate stack or the ideal design of the package substrate stack from the first trace width to the second trace width.

In Example 29, the method of modelling the package substrate stack of Example 25 or 28, wherein the metal trace comprises a first trace portion and a second trace portion; wherein the first trace width is a trace width of the first portion, the second trace width is an amended trace width of the first portion; wherein the second trace portion comprises a third trace width; and further comprising selecting a fourth trace width of the second trace portion based on the determined signal integrity of the metal trace or the determined yield of the package substrate stack model.

In Example 30, the method of modelling the package substrate stack of Example 29, wherein selecting the fourth trace width comprises selecting the fourth trace width based on the determined signal integrity of the metal trace and the determined yield of the package substrate stack model

In Example 31, the method of modelling the package substrate stack of Example 30, further comprising selecting the fourth trace width based on the model of the real package substrate stack.

In Example 32, the method of modelling the package substrate stack of Example 31, further comprising changing the third trace width of the model of the package substrate stack or the ideal design of the package substrate stack from the third trace width to the fourth trace width.

In Example 33, the method of modelling the package substrate stack of any one of Examples 25 to 32, wherein selecting the second trace width and/or the fourth trace width comprises selecting the second trace width and/or the fourth trace width as a function of the signal integrity and the yield.

In Example 34, the method of modelling the package substrate stack of any one of Examples 25 to 33, further comprising generating the model of the real manufacture of the layer design by spatially resolving substrate manufacturing stacks.

In Example 35, a package substrate stack comprising a layer, wherein the layer comprises a metal trace; wherein the metal trace comprises a first portion having a first trace width and a second portion having a second trace width, wherein the first trace width is different from the second trace width. In Example 36, the package substrate stack of Example 35, further comprising a third portion between the first portion and the third portion, wherein the third portion comprises a gradient transition from the first trace width to the second trace width.

In Example 37, the package substrate stack of Example 35 or 36, wherein the metal trace comprises a fourth portion having a third trace width, different from the first trace width and the second trace width.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A package substrate stack modeler, comprising:
a manufacturing modeler, configured to generate a model of a real package substrate stack based on an ideal design of the package substrate stack;
a signal integrity model, configured to determine a signal integrity of a metal trace of the real package substrate stack;
a yield model, configured to determine a yield of the real package substrate stack;
wherein the metal trace comprises a first value of a trace variable;
further comprising a processor, configured to select a second value of the trace variable of the metal trace based on the determined signal integrity of the metal trace or the determined yield of the package substrate stack model.

2. The package substrate stack modeler of claim 1, wherein the processor is configured to select the second value of the trace variable based on the determined signal integrity and the determined yield.

3. The package substrate stack modeler of claim 2, wherein the processor is further configured to select the second value of the trace variable based on the model of the real package substrate stack.

4. The package substrate stack modeler of claim 1, wherein the trace variable is trace width.

5. The package substrate stack modeler of claim 1, wherein the trace variable is any one of trace width, trace-to-trace distance, distance to a next trace above the trace, or distance to a next trace below the trace.

6. The package substrate stack modeler of claim 1, wherein generating the model of the real package substrate stack comprises determining one or more deviations from the ideal design of the package substrate stack resulting from one or more manufacturing processes.

7. The package substrate stack modeler of claim 1, wherein the processor is further configured to change the trace width of the model of the real package substrate stack or the ideal design of the package substrate stack from the first trace width to the second trace width.

8. The package substrate stack modeler of claim 1, wherein the metal trace comprises a first trace portion and a second trace portion; wherein the first trace width is a trace width of the first portion, the second trace width is an amended trace width of the first portion; wherein the second trace portion comprises a third trace width; and
wherein the processor is further configured to select a fourth trace width of the second trace portion based on the determined signal integrity of the metal trace or the determined yield of the package substrate stack model.

9. The package substrate stack modeler of claim 8, wherein the processor is configured to select the fourth trace width based on the determined signal integrity of the metal trace and the determined yield of the package substrate stack model.

10. The package substrate stack modeler of claim 9, wherein the processor is further configured to select the fourth trace width based on the model of the real package substrate stack.

11. The package substrate stack modeler of claim 10, wherein the processor is further configured to change the third trace width of the model of the package substrate stack or the ideal design of the package substrate stack from the third trace width to the fourth trace width.

12. The package substrate stack modeler of claim 1, wherein the processor is configured to select the second trace width and/or the fourth trace width as a function of the signal integrity and the yield.

13. The package substrate stack modeler of claim 1, wherein the stack model is configured to generate the model of the real manufacture of the layer design by spatially resolving substrate manufacturing stacks.

14. The package substrate stack modeler of claim 1, wherein determining the signal integrity of the metal trace comprising determining any of impedance of the metal trace, cross talk between the metal trace and another metal trace, or insertion loss of the metal trace.

15. The package substrate stack modeler of claim 1, wherein determining the signal integrity of the metal trace comprises determining any of impedance of the metal trace, cross talk between the metal trace and another metal trace, or insertion loss of the metal trace.

16. The package substrate stack modeler of claim 1, wherein determine the yield of the real package substrate stack comprises determining an amount of yield loss of the real package substrate stack.

17. A non-transitory computer readable medium, comprising instructions which, if executed by one or more processors, are configured to cause the one or more processors to:
generate a model of a real package substrate stack based on an ideal design of the package substrate stack;
determine a signal integrity of a metal trace of the real package substrate stack, wherein the metal trace comprises a first value of a trace variable;
determine a yield of the real package substrate stack; and
select a second value of the trace variable of the metal trace based on the determined signal integrity of the metal trace or the determined yield.

18. The non-transitory computer readable medium of claim 17, wherein the instructions are further configured to cause the one or more processors to select the second value of the trace variable based on the determined signal integrity and the determined yield.

19. The non-transitory computer readable medium of claim 18, wherein the instructions are further configured to cause the one or more processors to select the second value of the trace variable based on the model of the real package substrate stack.

20. The non-transitory computer readable medium of claim 17, wherein the trace variable is trace width.

21. A package substrate stack comprising:
a layer, wherein the layer comprises a metal trace;
wherein the metal trace comprises a first portion having a first trace width and a second portion having a second trace width;
wherein the first trace width is different from the second trace width.

22. The package substrate stack of claim 21, further comprising a third portion between the first portion and the third portion, wherein the third portion comprises a gradient transition from the first trace width to the second trace width.

23. The package substrate stack of claim 21, wherein the metal trace comprises a fourth portion having a third trace width, different from the first trace width and the second trace width.
